(19) United States
(12) Patent Application Publication
(10) Pub. No.: US 2020/0027010 A1
(43) Pub. Date: Jan. 23, 2020

(54) Decentralized Distributed Machine Learning

(71) Applicant: Grey Jean Technologies LLC, New York, NY (US)

(72) Inventors: Thomas Lorenc, New York, NY (US); Cosmas Wong, New York, NY (US)

(73) Assignee: Grey Jean Technologies LLC, New York, NY (US)

(21) Appl. No.: 16/517,132

(22) Filed: Jul. 19, 2019

Related U.S. Application Data
(60) Provisional application No. 62/701,238, filed on Jul. 20, 2018.

(51) Int. Cl. G06N 5/04; G06N 20/00; G06N 3/04; G06F 16/25; H04L 9/06

(52) U.S. Cl. CPC G06N 5/043; G06N 20/00; H04L 2209/38; G06F 16/254; H04L 9/0637; G06N 3/04

(57) ABSTRACT

A machine learning application, such as a neural network, is implemented using blockchain technology. The blocks of the blockchain and connection data for the blocks define the machine learning application. Blockchain technology can be used to define changes to the machine learning application and/or propagate these changes from one computer system to other computer systems including the machine learning application.

### REFERENCE TO RELATED APPLICATIONS

The current application claims the benefit of co-pending U.S. Provisional Application No. 62/701,238, filed on 20 Jul. 2018, which is hereby incorporated by reference.

### TECHNICAL FIELD

The disclosure relates generally to machine learning, and more particularly, to a decentralized, distributed machine learning solution.

### BACKGROUND ART

A blockchain is a list of linked blocks. Blocks can be added to the list using an iterative process. However, a block and a link cannot be edited or removed. The blockchain is protected from unauthorized changes by storage of the complete blockchain at multiple nodes on a network. Proposed additions to the blockchain are broadcast and approved by the nodes prior to being added to the blockchain. Conflicts can be resolved by using the blockchain for which the most nodes agree. In this manner, a blockchain can provide a highly secure solution that provides a complete publicly available history for a series of related events or transactions. An early application of a blockchain is cryptocurrency.

To date, machine learning architectures allow for distributed data or distributed models, but not both. A centralized data set can be partitioned into distributed nodes, but since all machine learning models must minimize the “loss” on a full set of training data, all the data must be available to one model. Such a solution is utilized to provide error detection.

For example, FIG. 1 shows an illustrative machine learning architecture according to the prior art. As illustrated, the architecture includes global knowledge (e.g., resilient distributed dataset). For example, the entire data set can be loaded into a cloud of distributed nodes. The data set is used by the various algorithms to function. As a result, the two main functions of machine learning, extract, transform, load (ETL)/exploration and model training/parameter tuning, are performed in one large library of functions. Spark, Watson, Azure are example of machine learning approaches that use this platform based approach.

### SUMMARY OF THE INVENTION

Aspects of the invention provide a decentralized, distributed machine learning environment. In a particular embodiment, a machine learning solution is implemented using a blockchain. An embodiment distributes both the data and the machine learning models to multiple computer systems in the environment. Each computer system calculates the back propagation weights. Blockchain technology can be used to provide serial, secure communications between the computer systems (e.g., calculating a nonce used to encrypt communications), propagation of changes to other computer systems, and/or the like. The machine learning application can be implemented using a neural network. In this case, the blocks of the blockchain can define neural nodes of the neural network and connection data for the blocks can define the links between the neural nodes. Blockchain technology can be used to define changes to the neural network, which can be propagated using blockchain technology.

A first aspect of the invention provides a machine learning computing environment comprising: a plurality of blockchain nodes, each blockchain node including: a computer system; and a blockchain stored on the computer system, wherein the blockchain includes: a plurality of blocks; and data regarding a plurality of connections between the blocks, wherein, when executed by the computer system, the blockchain implements a machine learning application.

A second aspect of the invention provides a computer system comprising: a set of computing devices; and a blockchain stored on the set of computing devices, wherein the blockchain includes: a plurality of blocks; and data regarding a plurality of connections between the blocks, wherein, when executed by at least one of the set of computing devices, the blockchain implements a machine learning application.

A third aspect of the invention provides a method of managing a machine learning application, the method comprising: implementing a neural network for the machine learning application in a machine language block program, wherein the machine language block program comprises program code that implements a plurality of neural nodes of the neural network and data regarding a plurality of connections between the plurality of neural nodes of the neural network; storing the machine language block program as a block of a blockchain on a computer system; executing, on the computer system, the machine language block program to process input data and generate predictive data; adjusting, on the computer system, a set of attributes of the neural network based on a difference between the predictive data and desired data; generating, on the one of the plurality of computer systems, a new block of the blockchain and connection data for the new block, wherein the new block of the blockchain includes the machine language block program and the connection data for the new block defines the adjusted set of attributes; and adding the new block and connection data for the new block to the blockchain.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative machine learning architecture according to the prior art.

FIG. 2 shows an illustrative decentralized, distributed machine learning environment according to an embodiment.

FIG. 3 shows an illustrative neural network according to an embodiment.

FIG. 4 shows an illustrative machine learning (ML) block program according to an embodiment.

FIG. 5 shows an illustrative machine learning (ML) node program according to an embodiment.

FIG. 6 shows an illustrative ML block program including a neural network according to an embodiment.

FIG. 7 shows an illustrative three layer neural node network according to an embodiment.

FIG. 8 shows an illustrative ML program implemented as a blockchain according to an embodiment.

FIG. 9 shows an illustrative data format that can be utilized by a neural network blockchain according to an embodiment.

FIG. 10 shows an illustrative data flow for processing neural network blockchain data according to an embodiment.

FIG. 11 shows an illustrative data flow diagram for a sender to communicate with prospects according to an embodiment.

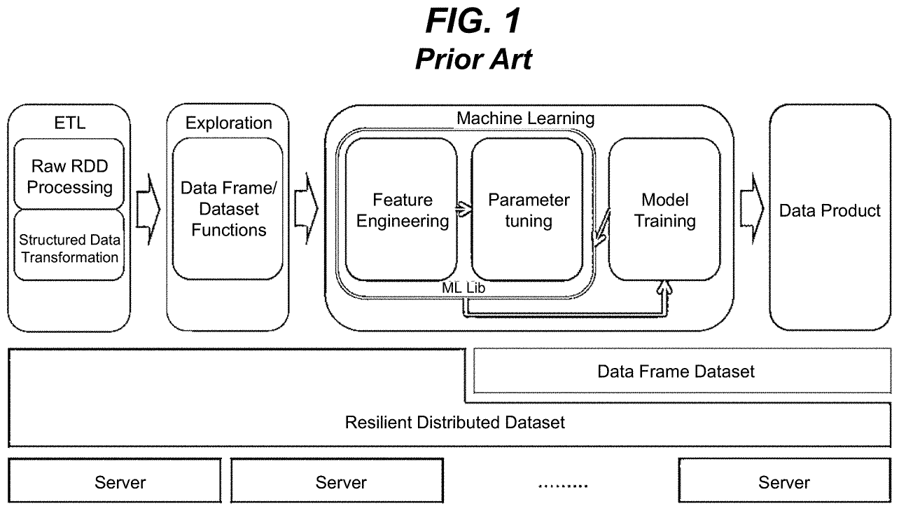

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As described herein, aspects of the invention provide a decentralized, distributed machine learning environment. In a particular embodiment, a machine learning solution is implemented using a blockchain. An embodiment distributes both the data and the machine learning models to multiple computer systems (e.g., blockchain nodes) in the environment. Each computer system calculates the back propagation weights. Blockchain technology can be used to provide serial, secure communications between the computer systems (e.g., calculating a nonce used to encrypt communications), propagation of changes to other computer systems, and/or the like. In this manner, an embodiment of the invention can provide a machine learning solution distributed in time.

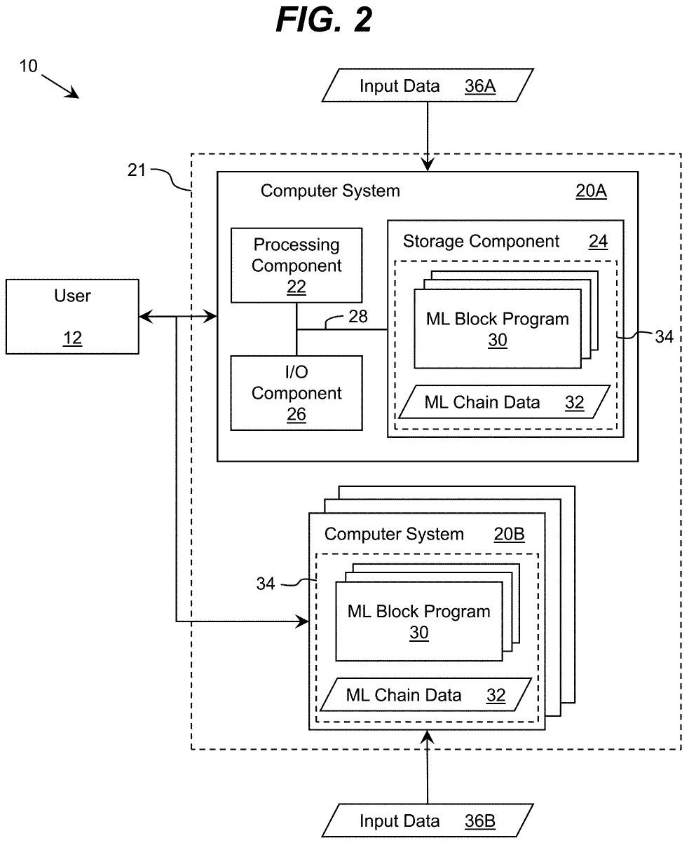

In an embodiment, the machine learning model itself is distributed with the data to different blockchain nodes of a blockchain application solution. For example, FIG. 2 shows an illustrative decentralized, distributed machine learning environment 10 according to an embodiment. To this extent, the environment 10 includes a set of computer systems 20A, 20B, each of which can perform a process described herein in order to provide a user 12 with a machine learning (ML) solution implemented using a blockchain ML platform 21. In particular, each computer system 20A, 20B is shown including a set of ML block programs 30 and ML chain data 32, which make the computer system 20 operable to provide the ML blockchain application solution for use by the user 12 by performing a process described herein.

Each computer system 20A, 20B can include one or more computing devices. To this extent, the computer system 20A is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, the processing component 22 executes program code, such as the ML block program 30, which is at least partially fixed in storage component 24. While executing program code, the processing component 22 can process data, which can result in reading and/or writing transformed data from/to the storage component 24 and/or the I/O component 26 for further processing. The pathway 28 provides a communications link between each of the components in the computer system 20A. The I/O component 26 can comprise one or more human I/O devices, which enable a human user 12 to interact with the computer system 20A and/or one or more communications devices to enable a system user 12 to communicate with the computer system 20A using any type of communications link. To this extent, the ML block program 30 can manage a set of interfaces (e.g., graphical user interface(s), application program interface, and/or the like) that enable human and/or system users 12 to interact with the ML block program 30. Furthermore, the ML block program 30 can manage (e.g., store, retrieve, create, manipulate, organize, present, etc.) the data, such as ML chain data 32, using any solution.

In any event, the computer system 20A can comprise one or more general purpose computing articles of manufacture (e.g., computing devices) capable of executing program code, such as the ML block program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the ML block program 30 can be embodied as any combination of system software and/or application software.

As described herein, the set of ML block programs 30 can be implemented as a blockchain 34. To this extent, each ML block program 30 can be linked to one or more other ML block programs 30 as defined by the ML chain data 32. In this case, each ML block program 30 can be a module of a larger blockchain program. As used herein, the term “component” means any configuration of hardware, with or without software, which implements the functionality described in conjunction therewith using any solution, while the term “module” means program code that enables a computer system 20A to implement the actions described in conjunction therewith using any solution. Regardless, it is understood that two or more components, modules, and/or systems may share some/all of their respective hardware and/or software. Furthermore, it is understood that some of the functionality discussed herein may not be implemented or additional functionality may be included as part of the computer system 20A.

When the computer system 20A comprises multiple computing devices, each computing device can have only a portion of the ML block program 30 fixed thereon. However, it is understood that the computer system 20A and the ML block program 30 are only representative of various possible equivalent computer systems that may perform a process described herein. To this extent, in other embodiments, the functionality provided by the computer system 20A and the ML block program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 20A includes multiple computing devices, the computing devices can communicate over any type of communications link. Furthermore, while performing a process described herein, the computer system 20A can communicate with one or more other computer systems 20B and/or the user 12 using any type of communications link. In either case, the communications link can comprise any combination of various types of optical fiber, wired, and/or wireless links; comprise any combination of one or more types of networks; and/or utilize any combination of various types of transmission techniques and protocols.

As illustrated, each computer system 20A, 20B in the environment 10 can include its own copy of the machine learning model, which can be stored as a blockchain 34. As such, each computer system 20A, 20B can correspond to a blockchain node. In this case, the environment 10 can provide a machine learning solution that includes redundancy as well as security, yielding a highly reliable solution. Each computer system 20A, 20B can process different input data 36A, 36B using the corresponding copy of the blockchain 34. As a result of such processing, the computer system 20A, 20B can make one or more changes to its copy of the blockchain 34. In an embodiment, the computer system 20A, 20B can embed changes to its copy of the blockchain 34 in a new block added to the blockchain 34. Changes made on one computer system 20A, 20B can be propagated to other copies of the blockchain 34 stored on other computer systems 20A, 20B via asynchronous peer-to-peer communication which can be implemented using blockchain technology. Header information for the new block (e.g., the corresponding ML chain data 32) can include the changes learned by the computer system 20A, 20B as a result of processing the corresponding input data 36A, 36B. Once added to its blockchain 34, the other computer system 20A, 20B can process the header information (e.g., included in the ML chain data 32) to incorporate the changes and subsequently process its data.

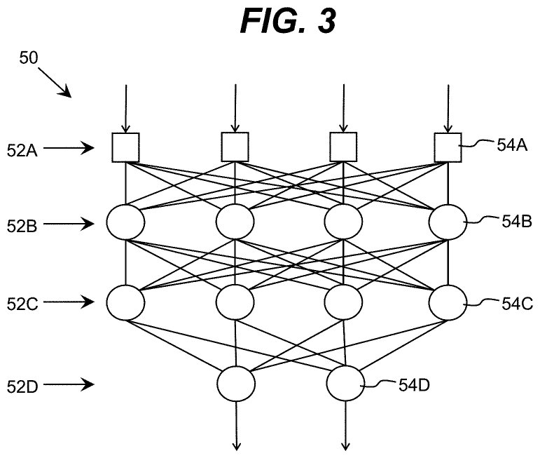

In a more particular embodiment, the machine learning environment is implemented using a neural network. To this extent, FIG. 3 shows an illustrative neural network 50 according to an embodiment. In this case, the neural network 50 includes multiple layers (e.g., a layer cake) 52A-52D, shown top to bottom, which can include an input layer 52A, an output layer 52D, and one or more hidden layers 52B, 52C located between the input and output layers. As illustrated, each layer can include one or more neural nodes 54A-54D, the output of which can be connected as an input to some or all of the neural nodes in an adjacent layer. The inputs of the neural nodes 54A located in the input layer 52A are the input data being analyzed (e.g., the input data 36A shown in FIG. 2), while the outputs of the output nodes 54D in the output layer 52D are the output data generated by the neural network 50.

In an embodiment, each ML block program 30 (FIG. 2) comprises one or more neural nodes 54A-54D in the neural network 50 and the ML chain data 32 (FIG. 2) includes data corresponding to the connection information between the ML block programs 30 forming the neural network 50. In a more particular embodiment, each ML block program 30 is configured to implement the neural network 50. For example, program code for implementing all of the neural nodes 54A-54D and the corresponding links can be included in a single ML block program 30 of a blockchain. In this case, as discussed herein, each ML block program 30 of the blockchain includes its own copy of the neural network 50, with modifications to the weights and/or other attributes of the neural network 50 being provided in the ML chain data 32 (FIG. 2) for each new block added to the blockchain. In this case, the computer system 20A, 20B (FIG. 2) can execute the ML block program 30 of the current (e.g., most recent) block of the blockchain 34 to perform a function.

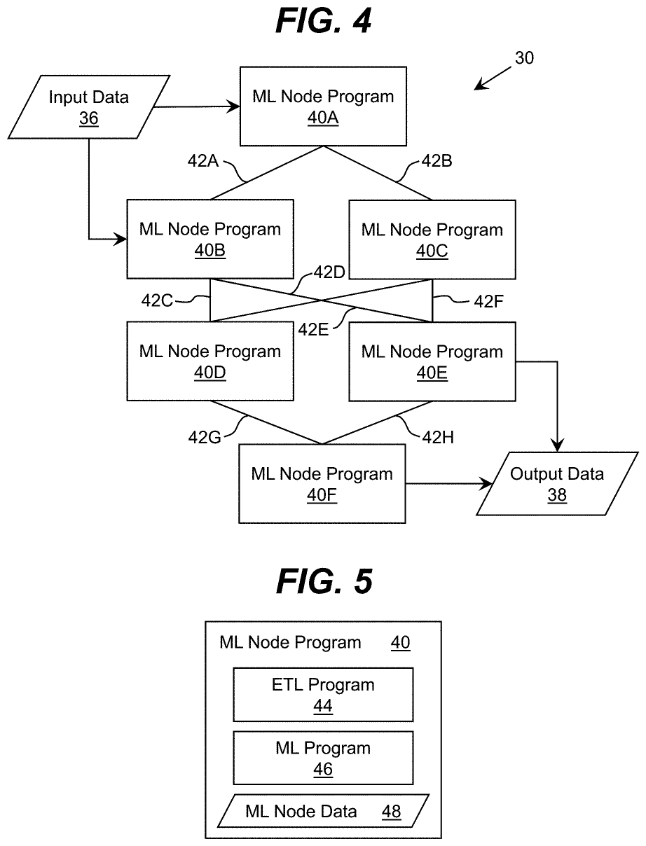

To this extent, FIG. 4 shows an illustrative machine learning (ML) block program 30 according to an embodiment. As illustrated, the ML block program 30 includes ML node programs 40A-40F, which are connected via links 42A-42H defined in the ML block program 30. In an embodiment, the machine learning (ML) block program 30 comprises a neural network with a cascade of layers. For example, a first layer can comprise ML node program 40A, followed by a layer including ML node programs 40B, 40C, followed by a layer including ML node programs 40D, 40E, followed by a layer including ML node program 40F. In this case, the links 42A-42H can comprise directional links as processing transitions from a first layer to the last layer. While the ML block program 30 is shown as implementing a neural network including four layers with one or two of the ML node programs 40A-40F in each layer, it is understood that a neural network can comprise any number of two or more layers, with each layer including any number of one or more ML node programs.

In an embodiment, the ML block program 30 is used to enable a smarter “thinking” machine learning process. In particular, instead of a large platform library as used in the prior art, the ML block program 30 can implement two of the smallest, configurable self-learning unsupervised neural nodes, an ETL node and an ML node, as ML node programs 40A-40F of the ML block program 30. Implementation of the ML block program 30 as a block of a blockchain can be used to distribute these nodes, e.g., using standard blockchain technology.

To this extent, FIG. 5 shows an illustrative ML node program 40 according to an embodiment. In this case, the ML node program 40 includes an extract, transform, load (ETL) program 44 and a machine learning (ML) program 46. In general, the ETL program 44 can acquire data from one or more sources, such as input data 36 and/or data included in a corresponding link 42A-42H, transform the data into data usable by the ML program 46, and load the data as ML node data 48 for processing by the ML program 46. The ML program 46 can process the ML node data 48 and generate a processing result, which can be passed on as input data via one or more links 42A-42H and/or as output data 38 for the ML block program 30.

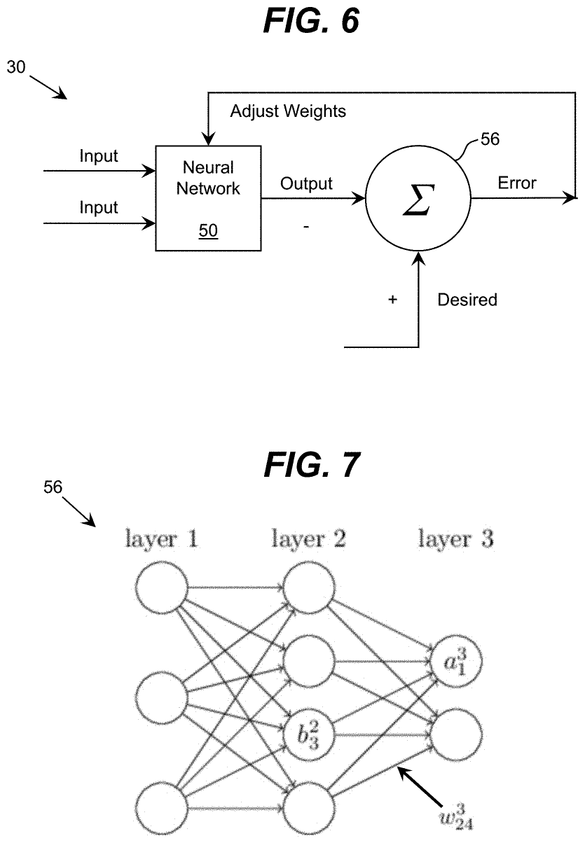

The ML block programs 30 of the neural network blockchain 34 can be configured to teach themselves the solution for a given problem. For example, if necessary, the ML block program 30 (FIG. 4) can adjust one or more weights (e.g., defined in the links 42A-42H) to reduce any error in a processing result. To this extent, FIG. 6 shows an illustrative ML block program 30 including a neural network 50 according to an embodiment. As illustrated, the neural network 50 processes one or more inputs and generates one or more outputs based on the input(s). After obtaining feedback regarding an accuracy of the output, the output can be provided as an input to an error analysis function (Σ) 56 included in the ML block program 30 along with a desired output as another input to the error analysis function 56. The error analysis function 56 can generate an error output which is fed back to make one or more adjustments to the neural network 50. For example, the weights and/or biases used in the neural network 50 can be varied to result in a more accurate output.

Returning to FIG. 4, the ML block program 30 can describe changes to the neural network, such as changes to one or more links 42A-42H, changes to the bias and/or activation of an ML node program 40A-40F, and/or the like, as current block data, e.g., stored within a data partition header of the ML chain data 32 (FIG. 2). In this manner, the neural network blockchain 34 can provide a self-learning neural network with new loss-minimizing machine learning models.

Effective error detection can be important to implement in machine learning. In general, error detection requires global knowledge that is back-propagated to its constituents. In an embodiment, each blockchain node (e.g., computer systems 20A, 20B shown in FIG. 2) can perform a loss minimization function on its own copy of the machine learning model (e.g., the neural network blockchain 34 of FIG. 4). In a more particular embodiment, the neural network blockchain 34 uses a distributed deep learning class of machine learning algorithms to implement error detection. To this extent, distributed deep learning algorithms comprise a neural network that uses a cascade of layers (tiers) of processing units to extract features from data and make predictive guesses about new data.

In an embodiment, the neural network blockchain 34 uses a probabilistic graph model (PGM) approach to deep learning (DL). In the PGM approach, the neural nodes can construct a probabilistic graph that defines the different variables of each relationship. The approach can use, for example, Monte-Carlo sampling to construct Bayesian consistent distributions for the variables. The neural network blockchain 34 can then use deep learning to learn from this synthesized data.

In an embodiment, an ML block program 30 (e.g., implementing a neural network as shown in FIG. 4) in the neural network blockchain 34 can read and process an entire chain of data or only a current block of data. After processing the data, the ML block program 30 can be optimized using any solution. For example, backpropagation of errors and/or gradient descent are illustrative optimization methods that can be used to calculate the error contribution of each neural node (e.g., ML node program 40A-40F shown in FIG. 4) after a batch of data is processed. Each neural node (e.g., ML node program 40A-40F) can perform the next in a series of its own gradient boosted back propagations that will result in gradient descent. In this case, the neural nodes can change their connection(s) and/or their weight(s) to lessen the error. As a result, the neural network blockchain 34 can determine a set of normal rules of the system, with unsupervised learning.

Backpropagation is an expression for the partial derivative ∂C/∂w of the cost function C with respect to any weight w (and/or bias b) in the network. The expression can indicate how quickly the cost changes in response to changes to the weights (and/or biases). To this extent, in addition to providing a solution for implementing learning, backpropagation can provide detailed insights into how changing the weights (and/or biases) changes the overall behavior of the neural network blockchain 34.

To this extent, FIG. 7 shows an illustrative three layer neural node network 56 (shown left to right) according to an embodiment. In this case, the first layer (layer 1) includes three neural nodes, the second layer (layer 2) includes four neural nodes and the third layer (layer 3) includes two neural nodes. The output of each neural node in a previous layer is provided as an input to each neural node in the next layer and has a corresponding weight, w. The weight, w, of each connection can be uniquely identified as w^{l}ⱼₖ, where j is the j^{th} neural node in the l^{th} layer and k is the k^{th} neural node in the (l−1)^{th} layer. The j^{th} and k^{th} neural node of a layer can be determined using any solution, e.g., by counting neural nodes along a direction of the layer (e.g., top to bottom in this illustration). To this extent, as illustrated in FIG. 7, w³₂₄ can correspond to the weight for a connection from the fourth neural node in the second layer to the second neural node in the third layer of the neural node network.

Similarly, a bias, b, of a neural node can be expressed as b^{l}ⱼ, where the corresponding neural node is the j^{th} neural node of the l^{th} layer. Furthermore, an activation, a, of a neural node can be expressed as a^{l}ⱼ, where the corresponding neural node is the j^{th} neural node of the l^{th} layer. As illustrated in FIG. 7, b²₃ corresponds to the bias of the third neural node of the second layer and a³₁ corresponds to the activation of the first neural node of the third layer.

As discussed herein, a goal of backpropagation is to compute the partial derivatives ∂C/∂w and ∂C/∂b of the cost function C with respect to any weight w or bias b in the network. The cost function can be expressed as:

$$C = \frac{1}{2 n} {\sum }_{x} {‖ y ( x ) - {a}^{L} ( x ) ‖}^{2} ,$$

where: n is the total number of training examples; the sum is over individual training examples, x; y=y(x) is the corresponding desired output; L denotes the number of layers in the network; and a^{L}=a^{L}(x) is the vector of activations output from the network when x is input.

In an embodiment, a blockchain node (e.g., a computer system 20A, 20B including a blockchain 34 as shown in FIG. 2) can use a new type of back propagation to propagate updates to the machine learning model to other blockchain nodes. For example, the neural network blockchain 34 (FIG. 4), when executed on a computer system 20A-20B, can compute partial derivatives ∂Cx/∂w and ∂Cx/∂b for a single training example of data and store the partial derivatives in the last blockchain connection data 32. This allows the neural network blockchain 34 to use the equations to design activation functions which have particular desired learning properties. Unlike prior approaches, the neural network blockchain 34 does not include a controlling machine learning manager cluster or a data lake.

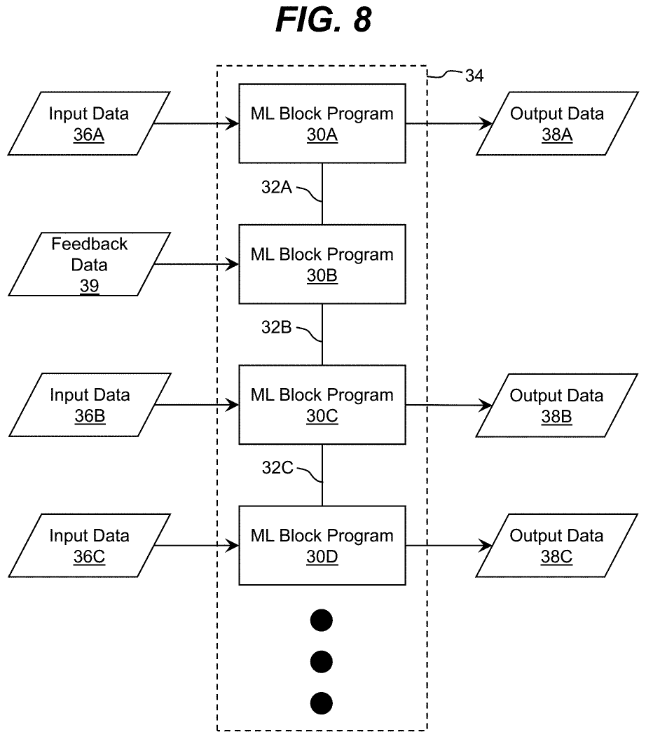

For example, FIG. 8 shows an illustrative ML program implemented as a blockchain 34 according to an embodiment. As illustrated, each block in the blockchain 34 can comprise an ML block program 30A-30D, which is configured to process input data and generate output data. For example, each ML block program 30A-30D can implement a neural network as shown in FIG. 4. During a first instance in time, the ML block program 30A can process input data 36A and generate output data 38A. Such processing can be affected by various attributes of the ML block program 30A. For example, when the ML block program 30A is a neural network, the processing is affected by the weights, biases, activation functions, etc., for the various nodes and their connections.

As part of the blockchain technology, a new block can be added to the blockchain after a fixed time duration (e.g., every 15 seconds). To this extent, the blockchain technology can generate blockchain connection data 32A for a new block 30B and add the new block 30B to the blockchain 34. In an embodiment, the new block is a copy of the previous block, e.g., the ML block program 30A, and the blockchain connection data 32A can comprise standard connection data.

Periodically, the blockchain 34 can process feedback data 39 corresponding to an accuracy of its output data. For example, the output data 38A can comprise data intended to predict one or more events based on the input data 36A. In this case, the feedback data 39 can comprise data regarding the accuracy of the predictions included in the output data 38A. As illustrated, such feedback data 39 can be provided to the ML block program 30B and processed (e.g., as described with reference to FIG. 6). The processing can result in one or more changes to the attributes of the ML block program 30B (e.g., weights, biases, activation functions, etc.). In this case, the ML block program 30B can include the change(s) to the attribute(s) in the connection data 32B for the next block being added to the blockchain 34. However, it is understood that changes may not be made based on the processing of the feedback data 39.

When executed, the ML block program 30C processes the changes defined in the connection data 32B. Subsequently, the ML block program 30C can process new input data 36B and generate output data 38B based on the processing. As a result of the changed attributes as defined in the connection data 32B, an accuracy of the output data 38B can be improved over the accuracy of the output data 38A. The same attributes can be implemented by multiple blocks of the blockchain 34. To this extent, as illustrated, a new ML block program 30D can be added to the blockchain 34 without having received any additional feedback data. In this case, the blockchain connection data 32C can include no changes to the attributes of the ML block program 30C. As a result, the ML block program 30D can process input data 36C and generate output data 38C using the same attributes as used by the ML block program 30C.

This process can continue over time as blocks are added to the blockchain 34. In this manner, the neural network can be trained over slices of time (e.g., as defined by the blockchain technology). Use of the blockchain technology allows the ML program to be highly responsive to changes as the addition of a new block provides an opportunity to make one or more changes to the neural network. Additionally, use of the blockchain 34 provides a robust history of the machine language program (e.g., neural network). For example, the blockchain 34 can be traversed to identify the attributes used by and/or recreate a previous version of the machine language program (e.g., neural network) at any given time, e.g., to evaluate why the neural network provided a particular result, troubleshoot one or more issues, etc.

As a result, a neural network implemented using the blockchain 34 as described herein can be self-organizing and self-correcting. A blockchain node with a machine learning model described herein can implement a decentralized asynchronous stochastic gradient descent neural network. In this case, no centralized server is present in the system. Instead, asynchronous peer to peer communication, which can be implemented through blockchain technology, can be used to transmit model updates between the blockchain nodes.

In an embodiment, a model update (e.g., one or more changes to one or more of the weights, biases, activation functions, etc. of the model) is forwarded in header information propagated to other blockchain nodes. In a more particular embodiment, the neural network blockchain 34 (FIG. 8) can use a variation of the structured streaming application programming interface (API) and the parquet data storage format to define the update, e.g., set one or more of the weights in a neural node connection (e.g., a link 32A-32H). To this extent, the neural network blockchain 34 can extend the data partition idea of the parquet data storage format to its logical conclusion and perform massive parallel pattern learning to set the weights of the neural nodes.

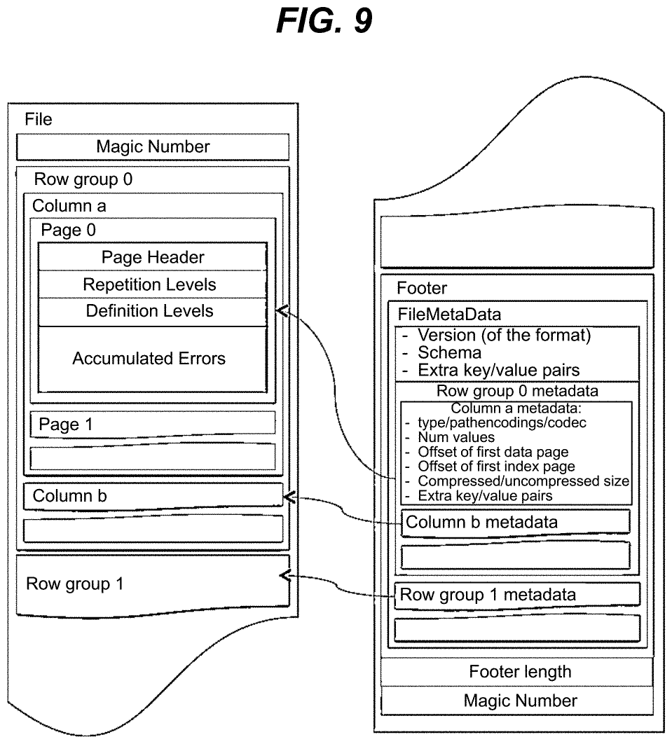

For example, FIG. 9 shows an illustrative data format that can be utilized by a neural network blockchain 34 according to an embodiment. As illustrated, input data can be stored as a file using a data format similar to the parquet data storage format, although it is understood that a file is only illustrative of various data storage formats. Regardless, the data file can include data corresponding to one or more row groups. Each row group can include one or more columns, and each column can include one or more pages. A page can include a page header and data corresponding to the update(s) to the model, such as repetition levels, definition levels, accumulated errors, and/or the like. A footer section of the file can include various types of metadata. For example, the footer can include metadata regarding the file (e.g., version information, schema, extra key/value pairs, etc.). Additionally, the footer can include metadata regarding one or more row groups, which itself can include metadata regarding one or more columns of a row group. For example, the row/column/page data can be compressed using one of various solutions. In this case, the column metadata can include data corresponding to the type/path encodings/codec, number of values, an offset of the first data page, an offset of the first index page, a compressed/uncompressed size, extra key/value pairs, and/or the like, which defines how to decompress and process the compressed row/column/page data.

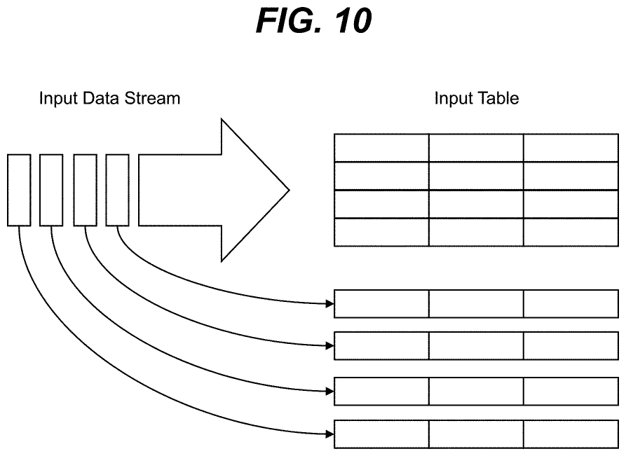

FIG. 10 shows an illustrative data flow for processing neural network blockchain data according to an embodiment. As illustrated, an input data stream can be converted into an input table for further processing. In an embodiment, the input data stream comprises one or more files having a data format as shown and described in conjunction with FIG. 9. However, it is understood that the data can be stored using any solution. Regardless, the input data stream can comprise data regarding new records (e.g., a row group as described herein), which can be processed into new rows that are appended to an unbound input table. The unbounded table can be stored as blockchain data.

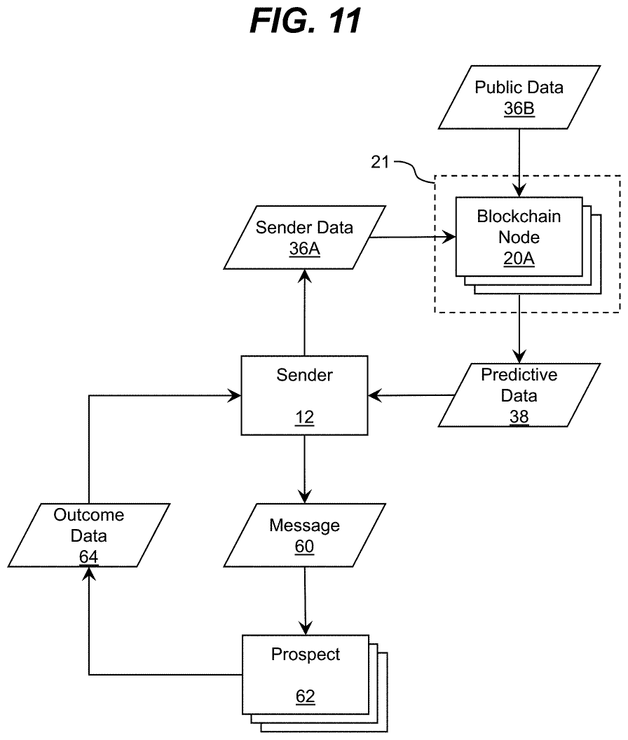

As is known, machine learning applications can be utilized in various applications. In an embodiment, a machine learning solution implemented using a blockchain ML platform 21 (FIG. 2) as described herein is configured to enable more effective communications between businesses and their customers (e.g., other businesses and/or consumers). To this extent, FIG. 11 shows an illustrative data flow diagram for a sender 12 to communicate with prospects 62 according to an embodiment.

A blockchain node 20A of the blockchain ML platform 21 can use proprietary sender data 36A and/or public data 36B to securely search through, manage, and learn from numerous potential segments to generate and provide predictive data 38 for use by a sender 12. Initial sender data 36A and/or public data 36B which can be provided to the blockchain node 20A can include, for example, past behavior, a consumer's age, home value, Facebook profile, current time of day, mobile phone location, temperature at mobile phone location, and/or any other consistently trackable data point.

The predictive data 38 can be unique for every one of numerous (e.g., millions) prospects 62 for a single brand, product, campaign, and/or the like, of the sender 12. The sender 12 can use the predictive data 38 to generate messages 60 that are sent to various prospects 62, e.g., as part of a campaign. In response to the messages 60, the sender 12 can receive outcome data 64 corresponding to the effectiveness of the messages 60. The sender 12 can provide some or all of the outcome data 64 as updated sender data 36A (e.g., feedback data 39 of FIG. 8) for processing by the blockchain node 20A. In this manner, the blockchain node 20A can be constantly learning from the positive and negative outcome data 64 for messages 60 generated based on the predictive data 38 to improve the predictive data 38 and the corresponding conversion rates associated with accurate predictions. Such a feedback process can be performed with the security and reliability of the blockchain technology.

In an embodiment, the blockchain ML platform 21, as embodied on various blockchain nodes 20A, can utilize a combination of three technologies: a unique learning capacity, superior processing of market segments, and decentralized blockchain integration, to provide superior predictive data 38 over that provided by prior art approaches.

For example, the blockchain ML platform 21 can leverage sender data 36A regarding the hits and misses of past communications to build a predictive model for each prospect 62 and each action (e.g., communication with the prospect by the sender 12). An important feature is an ability for the blockchain ML platform 21 to learn from how well the previous recommendations, as defined in the predictive data 38, worked. Even when the blockchain ML platform 21 makes accurate recommendations that significantly improve results, some recommendations will not produce results. Regardless, the blockchain ML platform 21 can examine the outcome data 64 to learn from the experience and improve a next round of predictions, regardless of a size of market or complexity of data points. This will reduce what the prospects 62 will consider pointless and annoying messages being received from the sender 12.

An advantage of the blockchain ML platform 21 is an ability to analyze and leverage data despite enormous volume and complexity. In an embodiment, updated outcome data 64 and/or public data 36B can be automatically tracked and incorporated into the updated model defined by the blockchain ML platform 21 based on transactions, social media, and CRM data collected and ingested. For example, if a sender 12 transmits a message 60 to prospects 62 based on the predictive data 38, and the sender 12 closes sales based on the message 60, the blockchain ML platform 21 can reinforce the pathway of correlations that drove the predictive data 38 that recommended the communication. Where a sale was not closed for a message 60 sent based on predictive data 38, the blockchain ML platform 21 can reduce a strength of the corresponding pathways that drove the recommendation. Such reinforcement and reduction can be defined in the connection data for a next block being added to the corresponding blockchain 34 (FIG. 8).

To this extent, the model defined by the blockchain ML platform 21 can be always shifting and updating itself automatically. What drives the exact changes and shifts can be difficult to detect and/or isolate because potentially hundreds of data points can be utilized. This is where the computational power of the blockchain ML platform 21 extends past the reach of traditional marketing. In essence, the blockchain ML platform 21 does not recognize changes the way a human does, but rather it tracks the trends that result from subtle changes in aggregated human behavior. The blockchain ML platform 21 can comprehensively manage and manipulate hundreds of factors (tracking sales, social media shares, press hits, online queries, etc.) to identify thousands of new patterns and correlations that are too subtle and complex for a human to identify and subsequently track and improve their translation to marketing recommendations.

Traditional marketing groups prospects 62 into segments based on various attributes of the prospects 62 that indicate that the prospects of each segment are likely to behave in a common, particular way. A sender 12 will then communicate with all prospects in the segment in the same manner.

An embodiment of the blockchain ML platform 21 can overcome inherent limitations of the traditional segments. For example, the blockchain ML platform 21 can consider many more attributes than is possible for a human marketer. To this extent, an embodiment of the blockchain ML platform 21 can consider attributes that number in “n-space” (where factor n is 150 or more). Furthermore, an embodiment of the blockchain ML platform 21 can enable increased customization of the messages sent to the prospects 62. For example, the predictive data 38 can include one or more recommendations regarding wording, product suggestions, timing, illustrations, pricing, etc., which can be customized down to the individual prospect 62, rather than segments of multiple prospects.

In still another embodiment, the blockchain ML platform 21 can take into account not just each prospect's 62 own behavior (what items they have clicked on, how often they place orders, what they have searched for), but also the purchasing behavior of other prospects 62 similar to the prospect. For example, if a prospect 62 is searching for Mother's Day gifts, the blockchain ML platform 21 can look at the prospect's 62 own purchasing behavior, and the behavior of other prospects also searching for similar gifts. Such functionality of the blockchain ML platform 21 can be enabled by, for example, item-to-item collaborative filtering, automated weighed and compared against an XgBoosted decision trees, whose best results can be optimized by, for example, an LSTM neural network, to solve the problem of existing algorithms being unable to scale to the massive volume of data with which the blockchain ML platform 21 can process. This solution focuses on the purchase distribution per category and subcategory, as opposed to per user. This allows for more stable purchase distributions, which equates to the ability to scale to huge datasets.

In still another embodiment, the blockchain ML platform 21 can use real-time data to enable the implementation of a truly agile prediction framework, while the automation afforded by the blockchain ML platform 21 data pipeline ensures errorless data collection. In an embodiment, the blockchain ML platform 21 can enable dynamic recommendations, such as pricing, for platforms that expect to deal with significant volume. For example, the blockchain ML platform 21 can recommend prices to a sender 12 (e.g., a retail store), taking into account multiple variables that have different weightings applied to them. In this case, assumptions behind an original algorithm can be tested against prior transaction data to create a model for the blockchain ML platform 21 based on actual outcomes. The blockchain ML platform 21 can use the classifier technique to calculate the likelihood of a product being bought based on the product's attributes and real-time market data.

In still another embodiment, the blockchain ML platform 21 computations can be stored in a recurrent neural network (RNN), e.g., which can be implemented by each ML block program 30 (FIG. 2). The RNN can have a number of layers, each one including long short-term memory (LSTM) cells. A recurrent neural network (RNN) can use a slightly different method of output computation, rather than other networks of different types. Specifically, the output of each neural node in each neural layer is passed to its input. This, in turn, allows the blockchain ML platform 21 to significantly improve the process of the neural network training, such as by reducing the number of neural layers required to provide meaningful results of prediction, as well as speed-up the training process by limiting the number of epochs during which the neural network is trained. As a solution for time-series prediction, an embodiment of the blockchain ML platform 21 can comprise multiple layers comprising LSTM cells being stacked up.

It is understood that embodiments of the blockchain ML platform 21 described herein can be utilized in various other applications. In the “non-sales” application space, the blockchain ML platform 21 can be used, for example, to gather information and statistics. In an illustrative embodiment, the blockchain ML platform 21 can acquire and process data for medical research, etc., linked to specialist devices. Furthermore, an embodiment of the blockchain ML platform 21 can be used to make real-time evaluations (e.g., in time to prevent the transaction from occurring) of proposed transactions, e.g., to identify potentially fraudulent transactions. In another embodiment, a blockchain ML platform 21 can be used to predict sales for a retailer over a specified time period in a specified geographic region.

When implemented within the current limitations of blockchain technology, the machine language program, e.g., neural network, defined in each ML block program 30 (FIG. 2) will need to be constrained to the block sizes permissible un the blockchain technology. To this extent, the machine language program can be configured to answer a specific question. In this case, a smaller neural network can be used to reliably evaluate the data and provide effective answers. However, it is understood that strict conformance with current blockchain standards is not required.

Regardless, embodiments of the blockchain ML platform 21 can provide various advantages over prior art solutions. For example, the neural networks defined by the blockchain ML platform 21 do not exist in isolation. Rather, they are embedded in a much larger blockchain environment 10 (FIG. 2). While the blockchain ML platform 21 can include duplication of various components, such duplication can provide redundancy to manage unexpected events, provide a mechanism to repurpose components, and/or the like.

In an embodiment, each blockchain node 20A, 20B of a blockchain ML platform 21 can implement a different predictive machine (e.g., due to different attributes being defined for a neural network). In this case, the blockchain ML platform 21 can react to a more diverse range of change as well as avoid correlated behavior that can lead to total system failure. Diversity is required for evolutionary learning and adaptation. Decoupling of components of the blockchain ML platform 21 can act like a firewall between the components, which can help mitigate against total collapse. Individual component damage can be tolerated by the blockchain ML platform 21 while the integrity of other components are preserved. In general, a distributed loosely coupled system has higher survivability that a centralized tightly coupled system, such as used in the prior art. Furthermore, the blockchain ML platform 21 described herein can be flexible and agile to adjust to changes in the environment. For example, the blockchain ML platform 21 can include adaptive approaches that involve simulation, selection, and amplification of successful strategies. Self-learning is requirement to achieve adaptability.

While shown and described herein as a method and system for implementing a machine learning solution using a blockchain, it is understood that aspects of the invention further provide various alternative embodiments. For example, in one embodiment, the invention provides a computer program fixed in at least one computer-readable medium, which when executed, enables a computer system to implement machine learning using a blockchain. To this extent, the computer-readable medium includes program code, such as the ML block programs 30 (FIG. 2), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as the ML block programs 30 (FIG. 2), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for implementing a machine learning solution using a blockchain. In this case, the generating can include configuring a computer system, such as the computer system 20 (FIG. 2), to implement the machine learning solution using a blockchain as described herein. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A machine learning computing environment comprising:
a plurality of blockchain nodes, each blockchain node including:
a computer system; and
a blockchain stored on the computer system, wherein the blockchain includes:
a plurality of blocks; and
data regarding a plurality of connections between the blocks, wherein, when executed by the computer system, the blockchain implements a machine learning application.

2. The environment of claim 1, wherein each block of the plurality of blocks implements a neural network including a plurality of neural nodes and a plurality of links between the neural nodes.

3. The environment of claim 2, wherein the neural network comprises a plurality of layers of neural nodes.

4. The environment of claim 2, wherein the data regarding at least one of the plurality of connections includes data identifying a change to at least one attribute of the neural network.

5. The environment of claim 2, wherein each block of the plurality of blocks includes a plurality of machine learning node programs, each of which corresponds to a neural node of the neural network.

6. The environment of claim 5, wherein each machine learning node program comprises:
an extract, transform, load (ETL) program; and
a machine learning (ML) program, wherein the ETL program is configured to transform input data into ML node data suitable for processing by the ML program, and wherein the ML program is configured to generate an output based on processing the ML node data.

7. The environment of claim 1, wherein a blockchain node of the plurality of blockchain nodes is configured to:
process, using a current block of the blockchain, input data to generate output data for use by a user;
adjust, using a current block of the blockchain, one or more attributes of the machine learning application based on feedback data received from the user after using the output data;
add a new block and a corresponding new connection for the new block to the blockchain, wherein data regarding the new connection defines the adjusted one or more attributes; and
forward data corresponding to the new block and the corresponding new connection for the new block for processing by at least one other of the plurality of blockchain nodes.

8. The environment of claim 7, wherein the data regarding the new connection comprises an unbounded input table including a plurality of rows, wherein each row defines a change to an attribute.

9. The environment of claim 1, wherein at least two of the plurality of blockchain nodes process different input data and comprise blockchains defining the machine learning application with different attributes.

10. The environment of claim 1, wherein the machine learning application processes past behavior data and generates predictions for use by a sender in communicating with a plurality of prospects.

11. The environment of claim 1, wherein the machine learning application evaluates a potential transaction and makes a determination as to whether the potential transaction is fraudulent in real time.

12. A computer system comprising:
a set of computing devices; and
a blockchain stored on the set of computing devices, wherein the blockchain includes:
a plurality of blocks; and
data regarding a plurality of connections between the blocks, wherein, when executed by at least one of the set of computing devices, the blockchain implements a machine learning application.

13. The computer system of claim 12, wherein each block of the plurality of blocks implements a neural network including a plurality of neural nodes and a plurality of links between the neural nodes.

14. The computer system of claim 13, wherein the neural network comprises a plurality of layers of neural nodes.

15. The computer system of claim 13, wherein the data regarding at least one of the plurality of connections includes data identifying a change to at least one attribute of the neural network.

16. The computer system of claim 13, wherein each block of the plurality of blocks includes a machine learning program having a plurality of attributes.

17. The computer system of claim 16, wherein the data regarding at least one of the plurality of connections includes data identifying a change to at least one of the plurality of attributes.

18. The computer system of claim 12, wherein the blockchain defines a plurality of versions of the machine learning application, and wherein the set of computing devices execute the machine learning application of the current block of the blockchain to perform a function.

19. The computer system of claim 18, wherein the function comprises predicting at least one of: an effectiveness of an action, a validity of a transaction, or an occurrence of at least one event.

20. A method of managing a machine learning application, the method comprising:
implementing a neural network for the machine learning application in a machine language block program, wherein the machine language block program comprises program code that implements a plurality of neural nodes of the neural network and data regarding a plurality of connections between the plurality of neural nodes of the neural network;
storing the machine language block program as a block of a blockchain on a computer system;
executing, on the computer system, the machine language block program to process input data and generate predictive data;
adjusting, on the computer system, a set of attributes of the neural network based on a difference between the predictive data and desired data;
generating, on the one of the plurality of computer systems, a new block of the blockchain and connection data for the new block, wherein the new block of the blockchain includes the machine language block program and the connection data for the new block defines the adjusted set of attributes; and
adding the new block and connection data for the new block to the blockchain.
